(19) United States
(12) Patent Application Publication
(10) Pub. No.: US 2006/0284428 A1
(43) Pub. Date: Dec. 21, 2006

(54) High reliability gate lock for exterior use

(76) Inventors: Darryl Beadle, (US); Gerard R. Pelletier, (US)

Correspondence Address: WILLIAM H. HOLLIMON;MOYLE, FLANIGAN, KATZ, RAYMOND & SHEEHAN, P.A., 118 N. GADSDEN STREET, TALLAHASSEE, FL, 32301, US

(21) Appl. No.: 11/150,874

(22) Filed: Jun. 13, 2005

(51) Int. Cl. E05C 19/00

(52) U.S. Cl. 292/302

(57) ABSTRACT

An improved gate lock provides for easy engagement and allows for a high degree of variability of the orientation and position of the mating portions of the lock. The lock includes a lock pin movably retained in a base. The pin coordinates with, and engages, a latch in a separate receiver to provide a physical lock. The latch is spring-mounted in a locked position to allow it to slide laterally within the receiver to receive and capture the pin during the locking function. The receiver includes a pin slot or opening having an angled surface for directing the pin into the latch for easier movement and engagement. The latch has an angled or curved strike surface on which the pin slides during locking. A solenoid is mounted to the receiver and is connected to the latch to provide for automatic withdrawal of the latch for unlocking functions.

### BACKGROUND OF THE INVENTION

The present invention pertains to door and gate latches and locks. In particular, the present invention regards latches and locks for large outdoor security gates typically having powered operators.

Agricultural and livestock operations, personal residences, and commercial businesses often have perimeter security fences or walls with access gates. Particularly where access gates are designed to provide passage of vehicles, security gates are generally large and heavy. Also, for a variety of reasons, such gates are often unmanned and automatically controlled. Operation of such gates is typically by a powered operator, most generally electrically powered. Security gates must include locking elements and where operation is unmanned and automatic, locking functions should be reliable and integrated into gate opening and closing operations.

Due to both the size and weight and loose manufacturing tolerances of typical outdoor security gate structures, and the weathering by the surrounding environment, precise alignment of coordinating latch and lock elements may be difficult to obtain. As a consequence, latch and lock designs applicable to smaller doors or building interior equipment may be unreliable for outdoor security gates. For reliable use, outdoor gate latch and lock elements should be ruggedly designed and built and allow for a degree of misalignment or variability of the gate structures.

There are many prior designs of latches and locks for doors and gates. However, none fully address the problems outlined above, nor provide an adequate solution.

### SUMMARY OF THE INVENTION

The present invention is a gate lock that provides for easy engagement of the locking elements while accommodating a high degree of variability of the mating portions of the fixed and movable elements of an associated gate.

The inventive lock includes a lock pin movably retained in a base. The pin coordinates with, and engages, a latch to provide a physical lock. The latch is spring-mounted in a locked position while allowing it to slide within a hollow receiver to receive and capture the pin during the locking function. The receiver includes a transverse slot or opening having an angled surface for directing the pin into the latch for easier movement and engagement. The latch has an angled or curved strike surface on which the pin slides during locking. A latch motive device is mounted to the receiver and is connected to the latch to provide for automatic withdrawal of the latch for unlocking functions.

The combination of the moveable pin, the enlarged pin opening and the angled guide surface in the receiver and the latch strike surface geometry allow for an easy and reliable automatic locking function while accommodating variability of the relative orientations and positions of the pin and receiver.

In use, the pin base and pin are preferably mounted in a fixed location on a gate frame bollard or the equivalent, while the latch receiver is mounted on a moveable swing-type gate. In this manner, when the gate is closed, the latch receiver approaches the pin such that the pin is forced transversely into the receiver to slide the latch momentarily away to allow the pin to pass and there be automatically captured in a locked position. However, alternatively in a reversed orientation, the pin base and pin may be mounted on the moveable gate and the receiver mounted in the fixed location.

The invention includes an automatic powered gate including a remotely operable lock of the present design. When used in conjunction with an automatic gate operator, the inventive lock preferably is automatically unlocked by operation of the lock solenoid prior to powered gate opening function.

A preferred embodiment of the inventive lock includes: a pin mount having an upper and lower flange retaining an elongated pin in slots that are longer than the diameter of the pin and a rectangular cross-section receiver body with a transverse slot including an angled guide surface for receiving the pin. A latch located within the receiver body is configured to slide within the receiver in locking and unlocking functions. The latch is spring loaded to maintain a locked position until withdrawn by activation of a connected solenoid. The latch has a latch arm that closes the receiver slot to retain the pin when locked. The latch arm has an angled or curved strike surface on which the pin bears when forced transversely into the receiver slot. The strike surface is configured such that when the pin is forced into the receiver slot it moves the latch away from the receiver slot, into the receiver.

Other aspects and advantages of the invention are illustrated and made apparent by the following discussion and accompanying figures of exemplary embodiments.

### DESCRIPTION OF THE DRAWINGS

FIG. 1a is a perspective view of a preferred embodiment of the invention.

FIG. 1b is a perspective view of the latch element of the embodiment of FIG. 1a.

FIG. 2 is a perspective view of the embodiment of FIG. 1 in a locked condition.

FIGS. 3a and 3b are section views of the embodiment of FIG. 1a showing the internal details of the lock receiver and latch with the latch in locked and withdrawn positions.

FIGS. 4a and 4b are detail plan views of various alternative geometries of the inventive latch.

FIG. 5 is a perspective illustration of the inventive lock on an associated automated gate.

### DESCRIPTION OF THE PREFERRED EMBODIMENTS

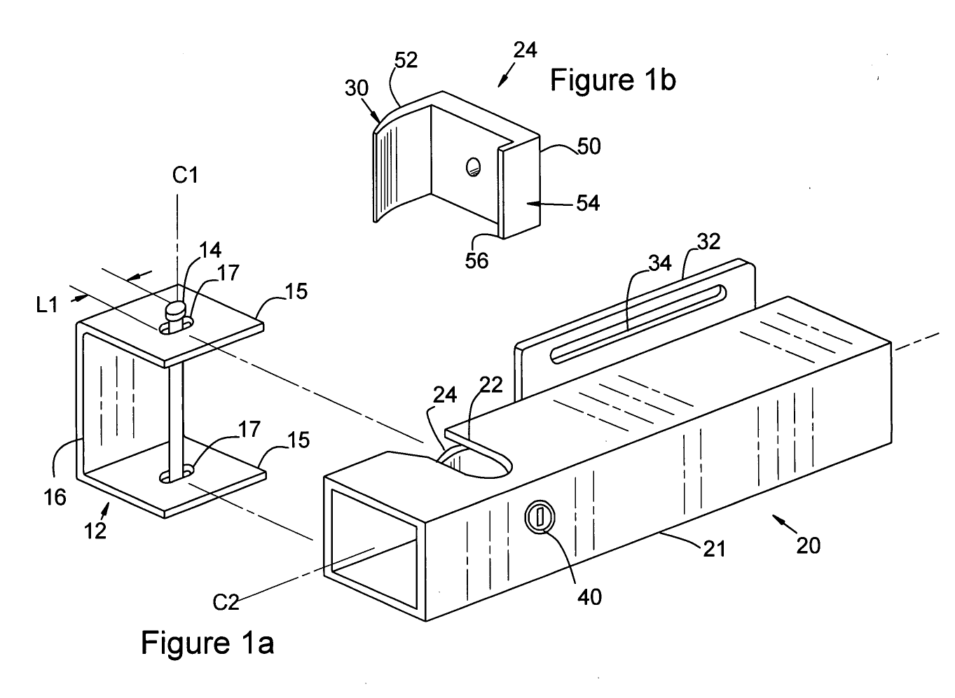

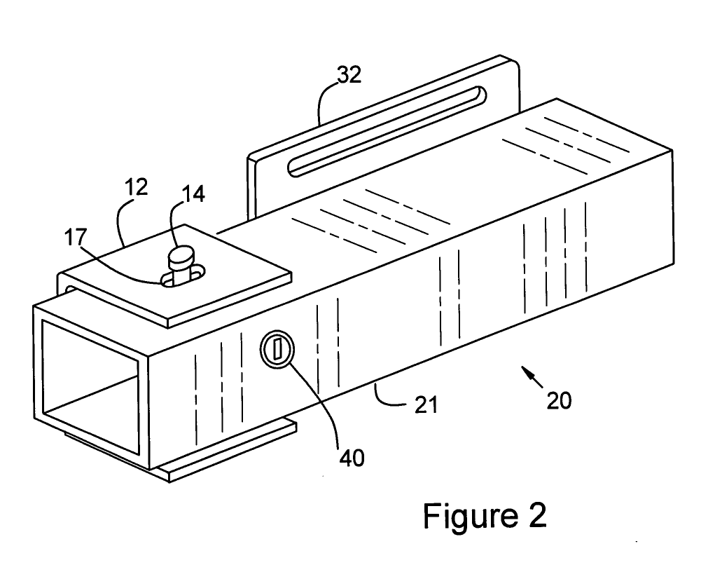

FIGS. 1a, b and FIG. 2 are perspective views of a preferred embodiment of the invention. In FIG. 1a, a pin mounting base 12 including a locking pin 14 is shown separated from a lock receiver 20 that includes a lock latch 24. In use, when unlocked and partially opened to allow an associated gate to move and open, the elements are oriented as shown. FIG. 2 depicts the same elements in a locked condition, where the pin 14 is held within the receiver 20 and retained there by the latch 24. FIG. 1b shows the geometry of the latch 24 separate from the remaining lock elements. Preferably, the receiver is mounted horizontally, as shown, on the moveable portion of a swinging gate, while the pin 14 is mounted with its long axis C1 vertical. However, other orientations that maintain the relative coordination and function of these components are possible and contemplated.

The pin mounting base 12 illustrated is formed of a rigid “C” shaped bracket having upper and lower horizontal flanges 15 extending, one distanced above the other, from a vertical mounting flange 16. The function of the pin base 12 is to hold and retain the locking pin 14 vertically at a determined location and orientation to ensure proper coordination with the receiver 20 during locking functions. Herein, the terms “horizontal” and “vertical” and like terms are intended to have only relative meaning; apply only in respect to the relative positions and orientations of the associated structures as shown in the figures; and no limitation on the placement, orientation, and use of the inventive lock as a whole is intended. The horizontal flanges 15 each have a generally centrally located pin slot 17. Each pin slot 17 preferably has a length dimension L1 approximately twice the diameter of the pin 14 and a respectively orthogonal width dimension slightly greater than the pin diameter. The pin 14 should move freely within the pin slots 17 to the extents of the pin slot 17. The pin 14 however, has enlarged ends or other means of retaining the pin 14 with the pin base 16. Each pin slot 17 is preferably oriented parallel to the mounting flange 16 such that the pin 14 is allowed to move in a direction perpendicular to the line of action or engagement between the pin 14 and the latch 24 when these elements engage. The purpose of this pin movement is discussed in a following section.

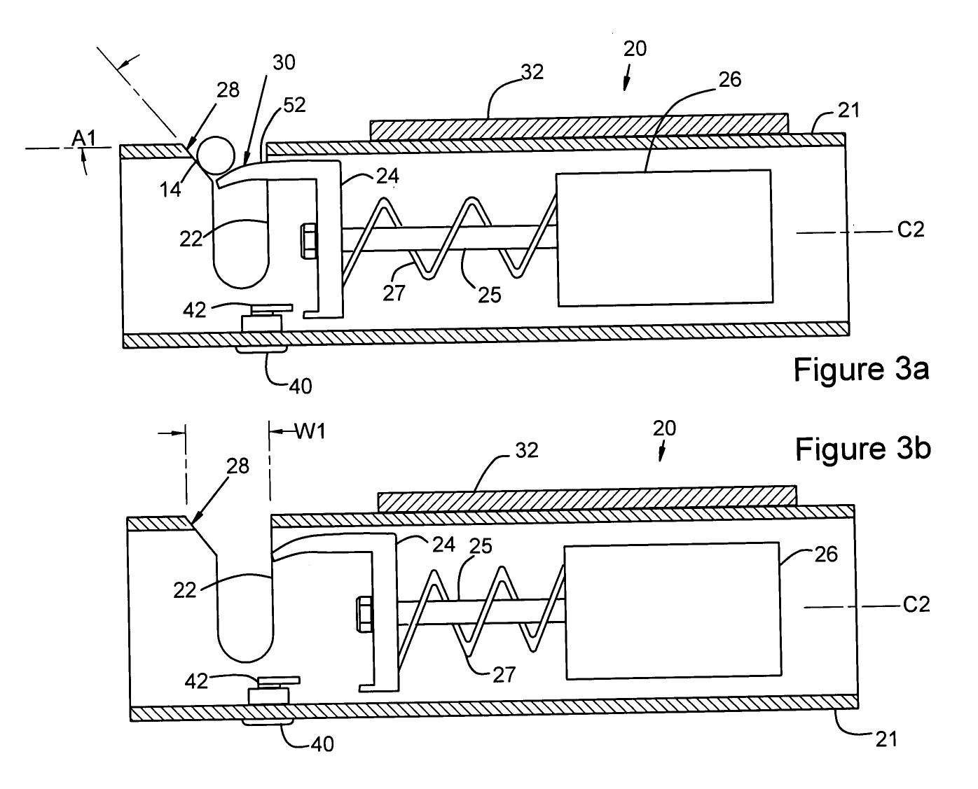

The latch 24 is retained in a rigid hollow receiver body 21 that, in the embodiment shown, is formed from a length of hollow rectangular section. FIGS. 3a and 3b provide illustration of the relative placement of the latch 24 and other elements of the receiver 20 within the receiver body 21. The receiver body 21 includes a generally vertical receiver slot 22 oriented and configured to allow the pin 14 to enter, transversely, into the receiver body 21 to engage the latch 24 as shown in FIG. 1a. Herein, the term “transverse” and forms thereof mean directions and movement perpendicular to the associated longitudinal axis of the pin or receiver. The mouth of the receiver slot 22 is widened by an angled guide surface 28 formed in the top and bottom and extending through a side wall of the receiver body 21. The guide surface 28 preferably has an included angle A1 less than 90 degrees and preferably about 45 degrees relative to the centerline C2 of the receiver body 21. The receiver slot 22 has a preferred minimum width dimension equal to about 1.5 times the diameter of the pin 14 and a maximum width W1 at the outer extent of the guide surface 28, of about 2.5 times the diameter of the pin 14.

The latch 24 consists of a generally rectangular base 50, a latch arm 52 extending from one side of the base 50, and a bearing surface 54 on a parallel side opposite the latch arm 52. Opposite the latch arm 52, a lip 56 extends in the same direction as the latch arm 52 to provide guidance with a manual lock operator as will be discussed below. The latch arm 52 is curved at least over a distal portion to engage the pin 14 during a locking function, as will be detailed below, and is sufficiently long to extend across the receiver slot 22. The bearing surface 54 is configured to bear on the inside surface of the receiver body 21. The base 50 is sized and shaped to slide within the receiver body 21, with only sufficient gap on each side to allow sliding, so as to limit lateral movement of the latch 24 within the receiver 20. In this manner, if the receiver 20 contacts the pin with great velocity, the force transmitted to the latch 24 will be resisted by the bearing surface with little damage. Minimizing the gap between the latch base 50 and receiver body 21 will reduce dynamic effects of impacts. A relatively large bearing surface area will distribute impact forces to reduce sliding resistance and reduce damage.

The latch 24 is supported on a solenoid shaft 25 such that the latch 24 is positioned generally equidistantly from the inside surfaces of the hollow receiver body 21 to allow the latch to move freely along the length of the inside of the receiver body 21. A solenoid 26 is rigidly mounted to the receiver body 21 such that the operable solenoid shaft 25 is aligned approximately collinear with the receiver body centerline C2. The latch 24 is rigidly secured to the distal end of the shaft 25.

FIGS. 3a and 3b illustrate the position of the elements of the receiver 20 and the relative location and orientation of the operable elements of the inventive lock in use conditions. In FIG. 3a, the latch 24 is in a neutral locked condition; the solenoid 26 is not energized and the latch arm 52 is located crossing and blocking the receiver slot 22. A circular spring 27 located functionally between the latch 24 and the solenoid 26 biases the latch 24 away from the solenoid 26 to maintain this condition. The spring 27 is mounted in this manner for convenience and, in alternative configurations, the spring may be mounted between the latch 24 and other points rigid with the receiver body 21 to produce the same function.

During a closing function, an associated gate is closed such that the receiver 20 and pin 14 are forced together along the line of action shown in FIG. 1a. As shown in FIG. 3a, the pin 14 contacts the latch arm 52 on a curved latch strike surface 30, or contacts the angled slot guide surface 28. The force of the pin 14 on the strike surface 30 forces the latch 24 back against the spring 27 to provide an opening in the receiver slot 22 for the pin 14 to enter. After the pin 14 passes the latch arm 52, the latch 24 is automatically biased closed again by the spring 27 to capture the pin in the receiver slot 22 in the locked condition. For this reason, the latch arm 52 is thin at its distal end to minimize the movement of the pin into the slot 22 before it passes, and it captured by, the latch arm 52. At the same time the latch arm 52 should me both rigid and strong enough to endure repeated striking by the pin.

If the pin 14 initially contacts the guide surface 28 (FIG. 3a), rather than the latch 24, the angle of the guide surface 28 directs the pin 14 to and against the latch arm 52. The angle of the guide surface 28, and hence the movement of the pin 14 on the guide surface 28, includes a component in the direction parallel to the solenoid shaft 25—and therefore in the direction of latch movement. In this way, the guide surface 28 allows the pin 14 to be directed into the slot 22 at the same time as the latch 24 is easily displaced. This lateral movement of the pin 14 is made possible by the length and orientation of the pin slot 17. This coordinated orientation and movement of the lock elements allow a greater tolerance in the pin's and receiver's relative locations that are effective in the desired locking functions. A pin that is slightly displaced from the receiver slot centerline will still easily enter the receiver and complete engagement for locking with the inventive device.

In FIG. 3b, in an unlocking function, the solenoid 26 is energized to withdraw the shaft 25 and the latch 24 against the bias of the spring force. This opens the receiver slot 22 to allow the pin to be released and allow the pin 14 and receiver 20 to separate, and the associated gate to be opened.

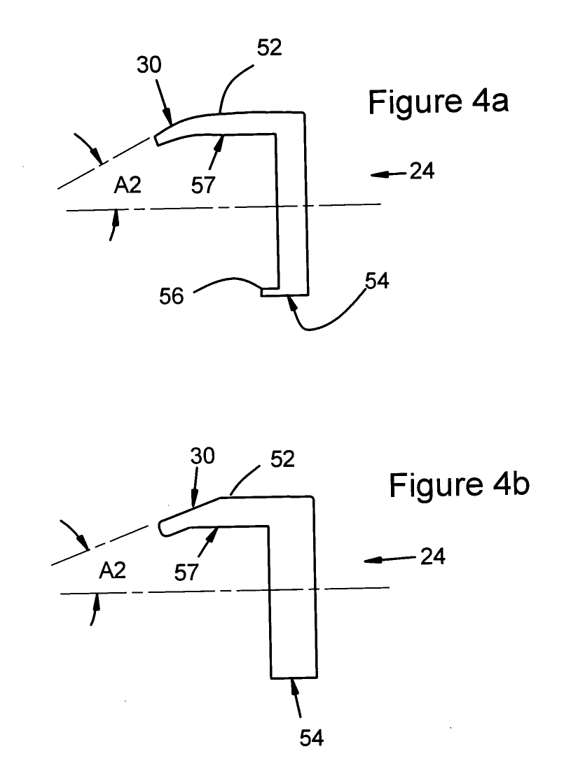

FIGS. 4a and 4b show exemplary latch configurations. Each is shown in cross-section; constant cross-section is presumed. However, constant cross-section is not necessary, only a convenience of manufacture. In each configuration, a latch arm 52 includes an outward facing strike surface 30 that at the latch arm distal end has an included angle A2 with respect to the line of movement of the latch (hence parallel to the receiver body centerline C2 when assembled). This produces a force component parallel to the direction of movement of the latch and that induces withdrawal of the latch 24 when a pin is forced against the latch arm 52 and bears on the strike surface 30. The strike surface 30 is angled over the entire extent exposed through receiver slot 22. Preferably, the strike surface included angle A2 is about 45 degrees. FIG. 4a shows the preferred embodiment of the latch 24 shown in FIG. 1b and having a latch arm 52 having a curved strike surface 30. The strike surface included angle A2 at the distal end of the curved latch arm 52 is about 45 degrees. Due to the curve, the angle of the strike surface 30 varies over the length of the latch arm and has a maximum at its distal end. In FIG. 4b, the latch arm strike surface 30 has a constant included angle of 45 degrees. The interior surface 57 of the latch arm of both configurations is flat or generally convex to ensure that outward force on a captured pin does not induce the latch 24 to withdraw. The bearing surface 54 is also shown.

To accommodate situations where there is a loss of power to the solenoid 26, or other situations requiring manual unlocking, the receiver 20 includes a manual key operator 40. The key operator includes an internally mounted operator arm 42 that, upon turning of a key in the key operator, rotates to bear against the latch base 50 to drive the latch into the open position. In this manner, the pin 14 may be released, and the associated gate opened, without operation of the solenoid. The operator arm 42 is positioned to contact the latch base 50 inside the latch lip 56 to ensure the operator arm 42 does not become jammed and interfere with the latch movement.

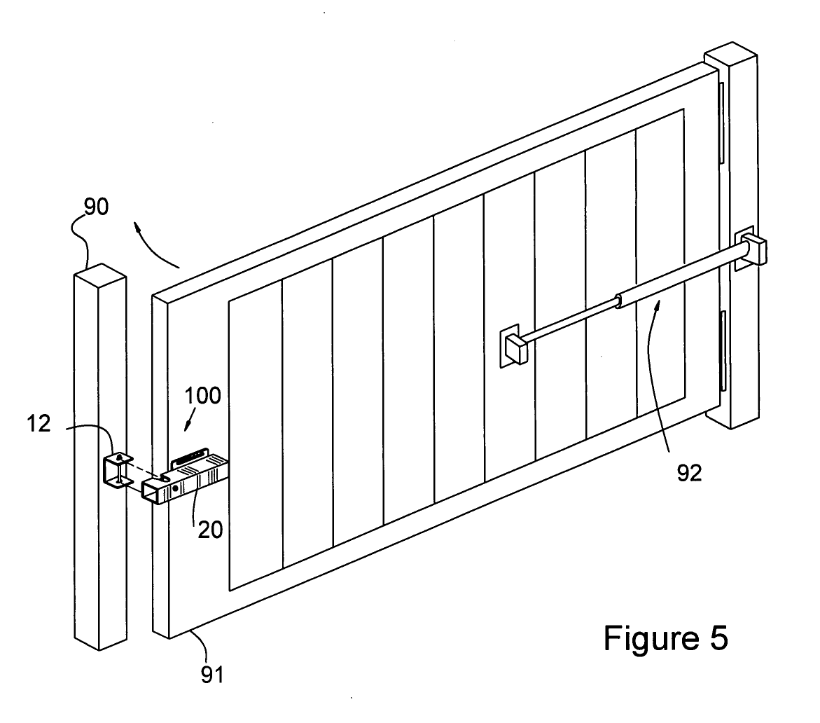

When the pin base 12 and receiver 20 are initially mounted to their respective gate elements, they are oriented with the pin 14 vertical to the respectively horizontal receiver. The pin longitudinal axis C1, when centered in the pin slots 17, should ideally fall on the center of the receiver slot 22 when the pin approaches the receiver. As discussed above, some variation in relative positioning will be tolerated with full functionality. FIG. 5 depicts a typical installation of the inventive lock assembly 100 on an exterior gate. The pin base 12 is mounted on a permanent gate bollard or post 90. The receiver 20 is mounted on a horizontally swinging gate 91 such that when swung closed, lock elements engage. In the figure, the gate is operated by a powered arm 92. The electrical power and control elements for the lock assembly are not shown, and will be specific to the particular components.

The pin base 12 may be mounted in any of a variety of commonly known methods such as welding or with threaded fasteners. The receiver 20 may be similarly mounted. In the embodiment shown, the receiver 20 includes a permanently attached receiver mounting plate 32 having mounting slots 34 to accept threaded, fasteners.

In alternative configurations, the receiver body 21 may have other cross-section shapes, such as, for example but not limited to: circular or square. Although a substantially closed section is preferred, open cross-section configurations that also provide the desired functions may be used. Environmental protection for operable elements mounted on an open configured receiver may be provided by other structures and means, such as separate coverings. Preferably, the open ends of the receiver body 21 shown are closed by temporary caps to increase protection from the environment.

Preferably, both the pin base 12 and receiver 20 are formed from thick walled structural steel or the equivalent to provide durability in outdoor use. Similarly, the pin 14 and latch 24 are preferably formed of corrosion resistant steel or equivalents.

Movement of the latch is preferably provided by a solenoid 26 as shown in the figures. Preferably, a low voltage, direct-current solenoid is provided. Alternatively, other devices and structures for providing the same latch movement and locking and unlocking functions may be used. These movement or drive means include an electric motor driven screw shaft, pneumatic or hydraulic driven shafts or linkage mechanisms and equivalent devices. The selection and design of the particular control and power elements required for the specific components will be known to those skilled in the art.

The preceding discussion is provided for example only. Other variations of the claimed inventive concepts will be obvious to those skilled in the art. Adaptation or incorporation of known alternative devices and materials, present and future, is also contemplated. The intended scope of the invention is defined by the following claims.

1. A gate lock providing enhanced accommodation for variation in lock orientation and high reliability, comprising:
a rigid pin having a longitudinal axis;
means of securing the pin to a working surface while allowing movement of the pin in a first direction perpendicular to the longitudinal axis;
a hollow lock receiver body having a centerline and having a slot perpendicular to the centerline, the slot configured to receive the pin transversely;
a latch slidably disposed within the receiver body and having a bearing surface configured to contact the receiver body; the latch also having a latch arm extending across the slot to close the slot in a locked condition, the latch arm configured to be forced away from the slot by a pin entering the slot;
a spring biasing the latch into the locked condition;
unlocking means for moving the latch within the receiver body to withdraw the latch arm from the slot to open the slot in an unlocked condition;
such that the pin and receiver may be locked together by moving the pin transversely into the slot while allowing the pin to move parallel to the receiver centerline, and the pin and receiver may be unlocked and separated by moving the latch to withdraw the latch arm from the slot.

2. A gate lock according to claim 1, and wherein:
the slot includes a guide surface having a guide surface included angle with respect to the centerline, the guide surface included angle less than 90 degrees.

3. A gate lock according to claim 2, and wherein:
the guide surface included angle is 45 degrees; and
the pin has a diameter and the slot has a maximum width dimension of 2.5 times the pin diameter.

4. A gate lock according to claim 1, and wherein:
the latch arm has a strike surface configured to receive a pin entering the slot, and the strike surface having a strike surface included angle of 45 degrees with respect to the centerline.

5. A gate lock according to claim 4, and wherein:
the strike surface is curved.

6. A gate lock according to claim 1, and wherein:
the securing means comprises an interconnected lower and upper flange; the lower and upper flange both having a respective pin slot configured to receive the pin, and the pin slot has a length equal to twice the pin diameter.

7. A gate lock according to claim 1, and wherein:
the unlocking means comprises an electrically powered solenoid.

8. A gate lock according to claim 1, and wherein:
the receiver body comprises a hollow tube having rectangular cross-section.

9. A gate lock providing enhanced accommodation for variation in lock orientation and high reliability, comprising:
a pin having a diameter;
a pin mount having an upper and lower flange; both flanges having a transverse pin slot having a length dimension equal to 1.5 times the pin diameter, the pin moveably secured in the upper and lower flange slot;
a receiver body comprising a hollow tube having a rectangular cross-section and having a centerline and having a transverse slot, the transverse slot having a guide surface having an included angle with respect to the centerline, the guide surface included angle less than 90 degrees;
a latch slidably disposed within the receiver body, the latch comprising:
a rectangular base having a first and second mutually parallel opposing side,
a latch arm extending generally perpendicularly from the first side, and
a bearing surface on the second side, the bearing surface configured to contact the receiver body;
a spring biasing the latch into a locked condition wherein the latch arm crosses the transverse slot;
a solenoid secured in the receiver body and connected to the latch to withdraw the latch arm away from the transverse slot in an unlocked condition;
the latch arm having a strike surface parallel to the pin when the pin is transversely directed into the slot, the strike surface also having a strike surface included angle of 45 degrees with respect to the centerline.

10. A gate lock according to claim 9, and wherein:
the guide surface included angle is 45 degrees.

11. A gate lock according to claim 9, and wherein:
the slot has a maximum width equal 2.5 times the pin diameter.

12. A gate lock according to claim 10 and further comprising:
a manual key operator configured to manually move the latch from the locked condition to the unlocked condition.
